(19) United States
(12) Patent Application Publication
(10) Pub. No.: US 2023/0148669 A1
(43) Pub. Date: May 18, 2023

(54) HEATER ASSEMBLY AND AEROSOL GENERATING APPARATUS INCLUDING THE SAME

(71) Applicant: KT&G CORPORATION, Daejeon (KR)

(72) Inventors: Jae Min LEE, Gyeonggi-do (KR); Hyung Seok LEE, Seoul (KR); Hwi Kyeong AN, Seoul (KR); Soung Ho JU, Daejeon (KR); Sang Kyu PARK, Seoul (KR)

(73) Assignee: KT&g CORPORATION, Daejeon (KR)

(21) Appl. No.: 17/596,860

(22) PCT Filed: Sep. 7, 2021
(86) PCT No.: PCT/KR2021/012094

§ 371 Date: Dec. 20, 2021

(30) Foreign Application Priority Data
Sep. 7, 2020 (KR) 10-2020-0113746
May 14, 2021 (KR) 10-2021-0062748

(51) Int. Cl. A24F 40/465; H05B 6/10; A24F 40/20; A24F 40/51

(52) U.S. Cl. CPC A24F 40/465; H05B 6/105; A24F 40/20; A24F 40/51

(57) ABSTRACT

A heater assembly for accommodating and heating an aerosol generating article includes an accommodation space into which the aerosol generating article is inserted, a coil surrounding at least part of the accommodation space and configured to generate an induced magnetic field, and a susceptor disposed in the accommodation space and configured to generate heat according to the induced magnetic field, wherein, in a state in which the aerosol generating article is fully inserted into the accommodation space, a distal end portion of the susceptor is placed upstream of a boundary between the tobacco rod and the filter rod by a preset distance inside the aerosol generating article.

### TECHNICAL FIELD

Embodiments relate to a heater assembly and an aerosol generating apparatus including the heater assembly, and more particularly, to a heater assembly capable of reducing a temperature of mainstream smoke at the beginning of a heating period, and an aerosol generating apparatus including the heater assembly.

### BACKGROUND ART

Recently, the demand for alternative methods to overcome the disadvantages of traditional cigarettes has increased. For example, there is growing demand for an aerosol generating device which generates an aerosol by heating an aerosol generating material in cigarettes or liquid storages without combustion.

There have been proposed new heating methods different from a conventional method using an electrical resistor-type heater. In particular, research on a method of heating cigarettes by using an induction heating method is actively being conducted.

### DISCLOSURE OF INVENTION

### Technical Problem

Unlike most aerosol generating devices that use an electrical resistor-type heater, an aerosol generating device that uses an induction heating method is capable of uniformly heating a tobacco rod of an aerosol generating article (e.g., a cigarette). Thus, there is a need for a different approach to the arrangement of a heater in the aerosol generating device that uses an induction heating method.

Problems to be solved by embodiments are not limited to the problems described above, and undescribed problems may be clearly understood by those skilled in the art to which the embodiments belong from the present specification and the accompanying drawings.

### Solution to Problem

According to one embodiment, a heater assembly for accommodating and heating an aerosol generating article including a tobacco rod and a filter rod includes an accommodation space into which the aerosol generating article is inserted, a coil surrounding at least part of the accommodation space and configured to generate an induced magnetic field, and a susceptor disposed in the accommodation space and configured to generate heat according to an induced magnetic field generated by the coil, wherein, in a state in which the aerosol generating article is fully inserted into the accommodation space, a distal end portion of the susceptor is placed upstream of a boundary between the tobacco rod and the filter rod by a preset distance.

According to another embodiment, an aerosol generating apparatus includes a heater assembly, a power supplier that supplies power to the heater assembly, and a controller that controls the power supplied to the heater assembly.

Technical solutions are not limited to the above descriptions and may include all matters that may be inferred by those skilled in the art throughout the present specification.

### Advantageous Effects of Invention

According to a heater assembly and an aerosol generating apparatus including the heater assembly according to the embodiments, a temperature of mainstream smoke may be reduced at the beginning of a heating period, and a consistent taste of smoke may be maintained throughout the heating period.

Effects of the embodiments are not limited to the above descriptions and may include all effects that may be inferred from configurations described below.

### BRIEF DESCRIPTION OF DRAWINGS

FIG. 1 is a view illustrating an aerosol generating apparatus using an induction heating method.

FIG. 2 shows a view showing an example of the aerosol generating article.

FIG. 3 is a view illustrating an example of a heater assembly and an aerosol generating article inserted into the heater assembly, according to an embodiment.

FIGS. 4A to 4C are views illustrating a change of a tobacco rod around a susceptor according to the passage of time.

FIG. 5 is a view illustrating an arrangement of a susceptor in an aerosol generating article.

FIG. 6 illustrates a temperature of a mainstream smoke according to an arrangement of a susceptor in a heater assembly according to an embodiment.

FIG. 7 is a view illustrating an example of a heater assembly according to another embodiment.

FIG. 8 is a cross-sectional view of a heater assembly according to another embodiment.

FIG. 9 is a cross-sectional view of a heater assembly according to another embodiment.

FIG. 10 illustrates a cross-sectional view of a susceptor and a heat insulating portion of a heater assembly according to another embodiment and a graph showing an example of a temperature distribution of the susceptor and the heat insulating portion.

FIG. 11 illustrates a cross-sectional view of a susceptor and a heat insulating portion of a heater assembly according to another embodiment and a graph showing an example of a temperature distribution of the susceptor and the heat insulating portion.

FIG. 12 illustrates a cross-sectional view of a susceptor and a heat insulating portion of a heater assembly according to another embodiment and a graph showing an example of a temperature distribution of the susceptor and the heat insulating portion.

### BEST MODE FOR CARRYING OUT THE INVENTION

According to one embodiment, a heater assembly for accommodating and heating an aerosol generating article including a tobacco rod and a filter rod includes an accommodation space into which the aerosol generating article is inserted, a coil surrounding at least part of the accommodation space and configured to generate an induced magnetic field, and a susceptor disposed in the accommodation space and configured to generate heat according to an induced magnetic field generated by the coil, wherein, in a state in which the aerosol generating article is fully inserted into the accommodation space, a distal end portion of the susceptor is placed upstream of a boundary between the tobacco rod and the filter rod inside the aerosol generating article.

In addition, the distal end portion of the susceptor may be apart from the boundary by about 0.3 to about 0.7 mm.

In addition, the susceptor may include a cylindrical base portion and a pointed portion formed at one end of the base portion.

In addition, the susceptor may generate heat which is about 270° C. to about 350° C.

In addition, the heater assembly may further include a heat insulating portion including a different material from the susceptor, coupled to the susceptor and a bottom of the accommodating space, and configured to absorb heat generated by the susceptor.

In addition, the heat insulating portion may be formed by stacking a plurality of members including different materials.

In addition, a first cavity may be formed inside the susceptor such that the heat insulating portion is exposed in the first cavity.

In addition, the heater assembly may further include a temperature sensor arranged to be in contact with the heat insulation portion in the first cavity.

In addition, a second cavity may be formed inside the heat insulating portion such that the susceptor is exposed in the second cavity.

In addition, the heater assembly may further include a temperature sensor arranged to be in contact with the susceptor in the second cavity.

In addition, the heat insulating portion may include an opening that is in fluid communication with the second cavity, and at least a portion of the susceptor may be inserted into the second cavity through the opening.

In addition, the heater assembly may further include a temperature sensor arranged to be in contact with the portion of the susceptor in the second cavity.

According to another embodiment, an aerosol generating apparatus includes a heater assembly, a power supplier that supplies power to the heater assembly, and a controller that controls the power supplied to the heater assembly.

### MODE FOR THE INVENTION

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”. “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The term “cigarette” may refer to a consumable article which can be loaded on an aerosol generating device to serve as a mouthpiece for a user. The cigarette may have a shape and a structure similar to those of a traditional combustive cigarette. The cigarette may contain an aerosol generating material that generates aerosols by operation (e.g., heating) of an aerosol generating device. Alternatively, the cigarette may not include an aerosol generating material, and delivers an aerosol generated from another article (e.g., cartridge) installed in the aerosol generating device to the user's mouth.

The term “downstream” refers to a direction in which the aerosol moves toward the mouth of a user in the aerosol generating article (e.g., cigarette) during smoking, and the term “upstream” refers to its opposite direction. The terms “downstream” and “upstream” may be used to indicate relative positions of components of the aerosol generating article. For example, a portion of a cigarette that is put in the user's mouth corresponds to a downstream end of the cigarette.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

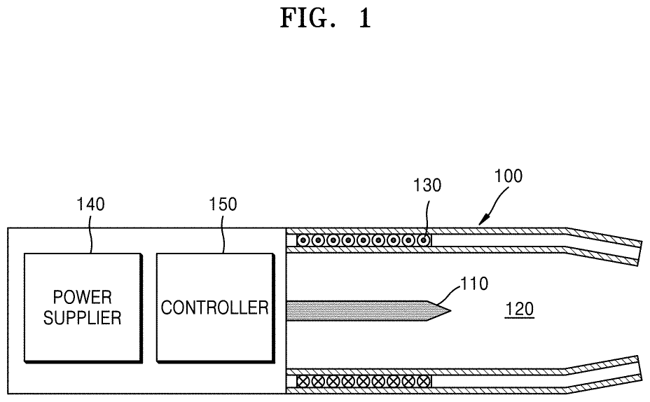

FIG. 1 is a view illustrating an aerosol generating apparatus using an induction heating method.

Referring to FIG. 1, an aerosol generating apparatus 100 may include a susceptor 110, an accommodation space 120, a coil 130, a power supplier 140, and a controller 150. However, the aerosol generating device 100 is not limited thereto, and may further include general-purpose components in addition to the components illustrated in FIG. 1.

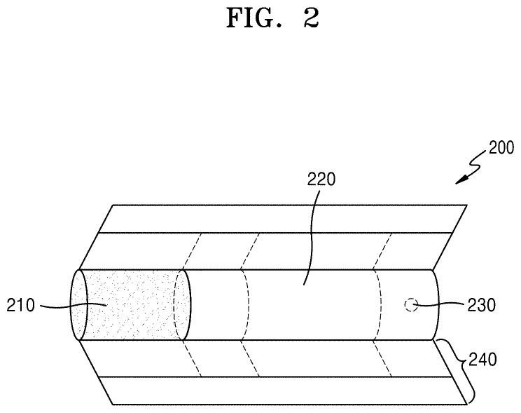

The aerosol generating device 100 may generate aerosol by heating an aerosol generating article (200 in FIG. 2) by using an induction heating method. The induction heating method may include a method of generating heat from a magnetic substance by applying an alternating magnetic field.

When an alternating magnetic field is applied to a magnetic substance, energy loss may occur in the magnetic substance due to eddy current loss and hysteresis loss. The lost energy may be released from the magnetic substance as thermal energy. As the amplitude or frequency of the alternating magnetic field applied to the magnetic substance increases, the heat energy released from the magnetic substance also increases. The aerosol generating apparatus 100 may heat a magnetic body by applying an alternating magnetic field to the magnetic body such that the aerosol generating article 200 is heated by the magnetic body.

A magnetic substance that generates heat by receiving an external magnetic field may be a susceptor. The susceptor 110 may have a form of a piece, a flake, a strip, or so on to be arranged in the aerosol generating device 100 instead of being included in the aerosol generating article.

The susceptor 110 may include metal or carbon. The susceptor 110 may include at least one of ferrite, ferromagnetic alloy, stainless steel, and aluminum (Al). In addition, the susceptor 110 may include at least one of ceramic (such as graphite, molybdenum, silicon carbide, niobium, nickel alloy, metal film, zirconia, or the like), transition metal (such as nickel (Ni) or cobalt (Co)), and metalloid (such as boron (B) or phosphorus (P)).

The aerosol generating device 100 may include an accommodation space 120 for accommodating an aerosol generating article 200. The accommodation space 120 may include an opening that opens to the outside of the accommodation space 120 to accommodate an aerosol generating article 200 in the aerosol generating device 100. An aerosol generating article 200 may be accommodated in the aerosol generating device 100 in a direction from the outside of the accommodation space 120 to the inside of the accommodation space 120 through the opening of the accommodation space 120.

The susceptor 110 may be arranged at the bottom of the accommodation space 120. The aerosol generating article 200 may be pushed down in the accommodation space 120 such that the susceptor 110 is inserted into the aerosol generating article 200 (e.g., cigarette).

The aerosol generating device 10) may include the coil 130 that applies an alternating magnetic field to the susceptor 110. The coil 130 may be wound around the accommodation space 120 such that the coil 130 may be disposed around the susceptor 110. The coil 102 may receive power from the battery 140.

As power is supplied to the coil 130, a magnetic field may be formed inside the coil 130. When an AC current is applied to the coil 130, the magnetic field formed in the coil 130 may periodically change in direction. When the susceptor 110 is exposed to an alternating magnetic field formed inside the coil 130, the susceptor 110 generates heat, thereby heating the aerosol generating article accommodated in the aerosol generating device 100.

When an amplitude or frequency of the alternating magnetic field formed by the coil 130 changes, a temperature of the susceptor 110 that heats the aerosol generating article 200 may also change. The controller 150 may adjust the amplitude or frequency of the alternating magnetic field formed by the coil 130 by controlling power supplied to the coil 130, and thus, the temperature of the susceptor 110 may be controlled.

For example, the coil 130 may be configured with a solenoid. The coil 130 may be a solenoid wound along a side surface of the accommodation space 120. The aerosol generating article 200 may be accommodated in the inner space of the solenoid. The solenoid may include copper (Cu), but it is not limited thereto. For allowing a large current to flow with a low specific resistance value, the solenoid may include any one of silver (Ag), gold (Au), aluminum (Al), tungsten (W), zinc (Zn), and nickel (Ni) or an alloy containing at least one thereof.

FIG. 2 shows a view showing an example of the aerosol generating article.

Referring to FIG. 2, the aerosol generating article 200 includes a tobacco rod 210 and a filter rod 220. FIG. 2 illustrates that the filter rod 220 includes a single segment, but is not limited thereto. In other words, the filter rod 220 may include a plurality of segments. For example, the filter rod 220 may include a first segment configured to cool an aerosol and a second segment configured to filter a certain component included in the aerosol. Also, as necessary, the filter rod 220 may further include at least one segment configured to perform other functions.

The aerosol generating article 200 may be packaged by at least one wrapper 240. The wrapper 240 may have at least one hole through which external air may be introduced or internal air may be discharged. For example, the aerosol generating article 200 may be packaged by one wrapper 240. As another example, the aerosol generating article 200 may be doubly packaged by two or more wrappers 240. Specifically, the tobacco rod 210 may wrapped by a first wrapper, and the filter rod 220 may be wrapped by a second wrapper. The tobacco rod 210 and the filter rod 220 which are individually wrapped may be coupled to each other, and the combined rods may be rewrapped by a third wrapper.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet.

Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod 210 may be increased and taste of the aerosol may be improved.

The filter rod 220 may include a cellulose acetate filter. The filter rod 220 may be formed in various shapes. For example, the filter rod 220 may include a cylinder-type rod or a tube-type rod having a hollow inside. Alternatively, the filter rod 220 may also be a recess-type rod having a cavity therein. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

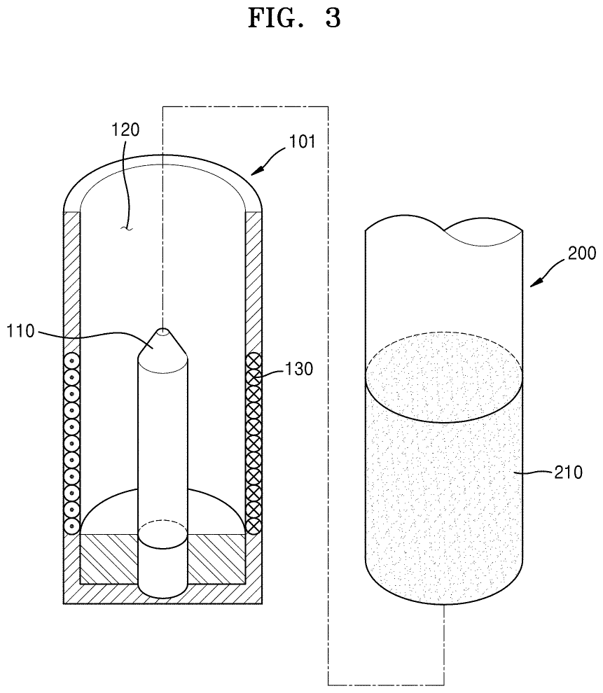

FIG. 3 is a view illustrating an example of a heater assembly and an aerosol generating article inserted into the heater assembly according to an embodiment.

Referring to FIG. 3, a heater assembly 101 may include the susceptor 110, the accommodation space 120, and the coil 130. However, the present disclosure is not limited thereto, and other general-purpose elements may be further included in the heater assembly 101.

At least a part of the aerosol generating article 200 may be accommodated in the accommodation space 120. The susceptor 110 may be inserted into the aerosol generating article 200 when the aerosol generating article 200 is accommodated in the accommodation space 120. The susceptor 110 may have a structure extending in the longitudinal direction to be inserted into the aerosol generating article 200.

The susceptor 110 may be arranged inside the accommodation space 120 and generate heat according to an alternating magnetic field induced by the coil. The susceptor 110 may be placed at the center of the accommodation space 120 to be inserted into the center of the aerosol generating article 200. In FIG. 3, the susceptor 110 is illustrated as one piece but is not limited thereto, and the heater assembly 101 may include a plurality of susceptors 110 that extend in the longitudinal direction to be inserted into the aerosol generating article 200 and are arranged in parallel to each other.

In a state in which the aerosol generating article 200 is fully inserted into the heater assembly 101 (i.e., when fully inserted into the accommodation space 120), the distal end portion of the susceptor 110 may be placed apart from a boundary between the tobacco rod 210 and the filter rod 220 of the aerosol generating article 200 by a preset distance. In other words, the distal end portion of the susceptor 110 may be placed upstream of the a boundary between the tobacco rod 210 and the filter rod 220. Details of an arrangement of the susceptor 110 in the aerosol generating article 200 are described below.

The coil 130 may surround at least a part of the accommodation space 120 and generate an induced magnetic field. The coil 130 may be wound around the accommodation space 120 along the longitudinal direction of the accommodation space 120. The coil 130 may be at a position corresponding to the susceptor 110. The coil 130 may extend in the longitudinal direction to have a length corresponding to the susceptor 110 and may be at a position corresponding to the susceptor 110.

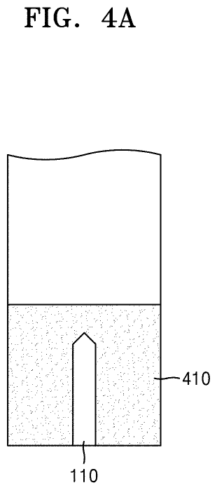

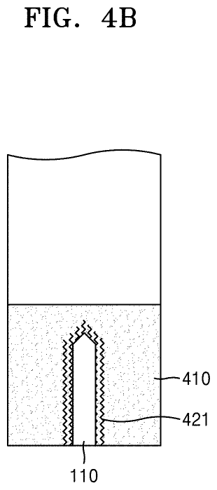

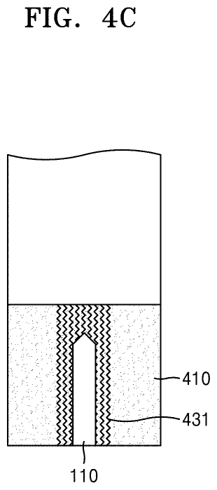

FIGS. 4A, 41B, and 4C are views illustrating a change of a tobacco rod around a susceptor according to the passage of time.

Referring to FIG. 4A, at a first point in time when the aerosol generating article 200 is inserted, the coil 130 and the susceptor 110 do not operate, and thus, the tobacco rod 410 is not yet heated and there is no change inside the tobacco rod 410.

Referring to FIG. 4B, the susceptor 110 generates heat by the coil 130 at a second point in time when a first time elapses from the first point in time, and thus, the tobacco rod 410 may be heated by the susceptor 110. In particular, cut tobacco 421 arranged around the susceptor 110 may contract by heat. Accordingly, density of the cut tobacco 421 around the susceptor 110 may be reduced (i.e., porosity of the tobacco rod 410 around the susceptor 110 may be increased).

Referring to FIG. 4C, the tobacco rod 410 is further heated by the susceptor 110 at a third point in time when a second time elapses from the second point in time. As a result, at the third point in time, the heat is transferred upstream such that the cut tobacco arranged above the susceptor 110 may also contract due to the heat. As a result, airflow holes 431 (i.e., airflow paths) through which air (and the aerosol) flows smoothly may be formed from the upstream end of the tobacco rod 410 to a boundary between the tobacco rod 410 and the filter rod 220 (i.e., the downstream end of the tobacco rod 410).

Here, each of the airflow holes 431 allows air introduced through the tobacco rod 410 to pass through the tobacco rod 410 to be transferred to the filter rod 220. The airflow holes 431 may be formed apart from a surface of the susceptor.

If the airflow holes 431 are formed too quickly, a temperature of mainstream smoke introduced into the filter rod 220 rapidly increases. Herein, the term “mainstream smoke” may refer to a mixture of air and the aerosol, which may be supplied to a user through an aerosol generating article. Given the limited cooling capacity of a first segment in the filter rod 220, if the temperature of the mainstream smoke is high, there is a high probability that an aerosol having particles smaller than a proper size is generated. In this case, there is a problem that the amount of atomization is greatly reduced. In addition, the mainstream smoke at a high temperature increases the amount of transfer of a tobacco material, and thus, a user is more likely to experience an excessively strong taste of tobacco.

In this regard, according to an embodiment, the susceptor 110 may be designed by considering the characteristics of the airflow holes 431, such as formation time, size, and so on.

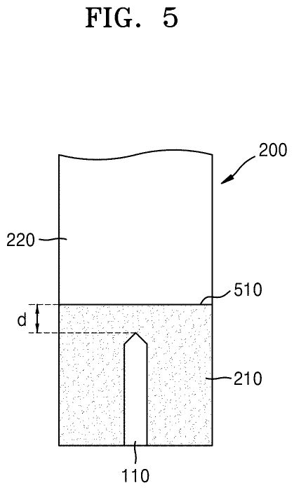

FIG. 5 is a view illustrating an arrangement of a susceptor in an aerosol generating article.

Referring to FIG. 5, when the susceptor 110 is inserted into the aerosol generating article 200, a distal end of the susceptor 110 may be positioned below (i.e., upstream of) a boundary 510 between the tobacco rod 210 and the filter rod 220.

When the preset distance d between the distal end of the susceptor 110 and the boundary 510 is set to be less than 0.3 mm, a temperature reduction effect of mainstream smoke may be greatly reduced. On the other hand, when the preset distance d is set to be greater than 0.7 mm, it is difficult to form the airflow holes in the tobacco rod 210, and thus the desired amount of atomization may not be produced. Therefore, the preset distance d may be 0.3 mm to 0.7 mm. In order to provide more uniform taste of smoke and more consistent amount of atomization over the entire heating period, the preset distance d may be 0.4 mm to 0.6 mm. For example, the preset distance d may be 0.5 mm.

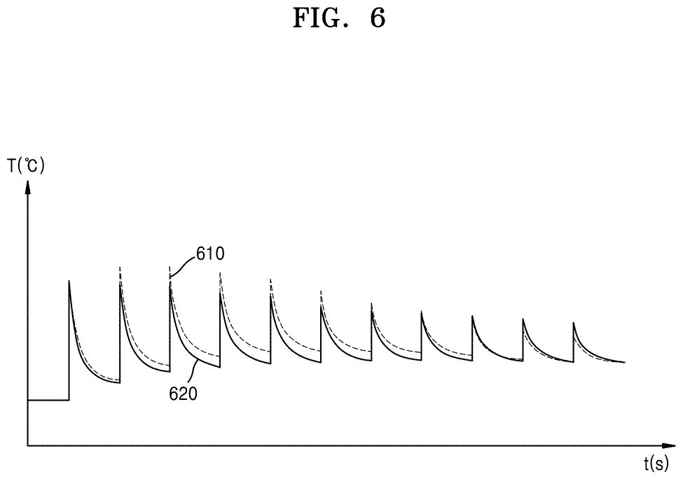

FIG. 6 illustrates a temperature of a mainstream smoke according to an arrangement of a susceptor in a heater assembly according to an embodiment.

In more detail, FIG. 6 illustrates a first temperature 610 of the mainstream smoke measured at the filter rod 220 when the preset distance d is less than 0.3 mm and a second temperature 620 of the mainstream smoke measured at the filter rod 220 when the preset distance d is 0.5 mm.

The total length of the time illustrated in FIG. 6 corresponds to a heating period, and graphs of the first and second temperatures 610 and 620 of FIG. 6 represent a change in temperature of the mainstream smoke with time in a heating period during which the heater assembly 101 heats one aerosol generating article 200.

In the entire heating period, an early stage, for example, a first half of the heating period including the heating start point may correspond to an “early stage of heating”, and the rest of the heating period may correspond to a “late stage of heating”.

Referring to FIG. 6, at the beginning of the heating period, the first temperature 610 is higher than the second temperature 620. Because of the limited cooling capacity of the filter rod 220, the first temperature 610 may reduce the amount of atomization. In addition, the first temperature 610 increases the amount of transfer of a tobacco material, and thus, a user may experience an excessively strong taste of tobacco.

In addition, in the late stage of heating, the first temperature 610 is lower than the second temperature 620. Since the first temperature 610 is lower than an optimum temperature for generating an aerosol, the amount of atomization may be greatly reduced in the late stage of heating. In addition, a large amount of tobacco material may be consumed in the early stage of heating, and thus the taste of tobacco may be greatly reduced in the late stage of heating.

In other words, if the preset distance d is set to be less than 0.3 mm, a smoking feeling may not be consistent throughout the heating period. On the contrary, if the preset distance d is set to 0.5 mm, a consistent smoking feeling may be provided throughout the heating period.

In an electric resistance heating-type heater of the related art, an electric resistance wire is inside the heater to be heated by electricity. Accordingly, a temperature of a portion of the heater in which the electric resistance wire is arranged may be different front a temperature of another portion of the heater in which the electric resistance wire is not arranged. In particular, in an electric resistance heating-type heater having a needle shape, an electric resistance wire cannot be arranged at the distal end portion of the heater due to its limited internal space. As a result, a temperature of the distal end portion of the heater is lower than temperatures of the other portions of the heater.

Airflow holes formed by the distal end portion of the heater are arranged at a position close to a boundary between a tobacco rod and a filter rod and formed relatively early in heating compared to airflow holes formed by the other portions of the heater. Therefore, the airflow holes formed by the distal end portion of the heater may significantly affect the amount of atomization and a taste of smoke in the early stage of heating. In the electric resistance heating-type heater, formation of the airflow holes near the distal end of the heater may be delayed in the early stage of heating due to the above-described low temperature of the distal end of the heater. In this regard, in some aerosol generating devices, the heater is arranged to pass through the boundary between the tobacco rod and the filter rod, such that the airflow holes are physically formed to extend through the boundary between the tobacco rod and the filter rod.

On the contrary, the heater assembly according to the embodiment includes a heater that is uniformly heated by induction heating, and thus a temperature of a distal end portion of a susceptor is sufficiently high compared to the electric resistance heating-type heater. Therefore, event if the distal end portion of the susceptor is placed upstream of the boundary between the tobacco rod and the filter rod, the airflow holes may be formed swiftly in the early stage of heating.

In this case, the number of airflow holes may be gradually increased throughout the entire heating period by heating of the susceptor, and thus the uniform amount of atomization and a consistent taste of smoke may be provided throughout the entire heating period compared to a case in which the airflow holes are physically formed.

In addition, according to the related art in which the heater contacts a filter rod, the performance of the filter rod may be reduced. On the contrary, according to the embodiment, a susceptor is placed only in the tobacco rod, and thus a structure of the filter rod is maintained without degrading the performance of the filter rod.

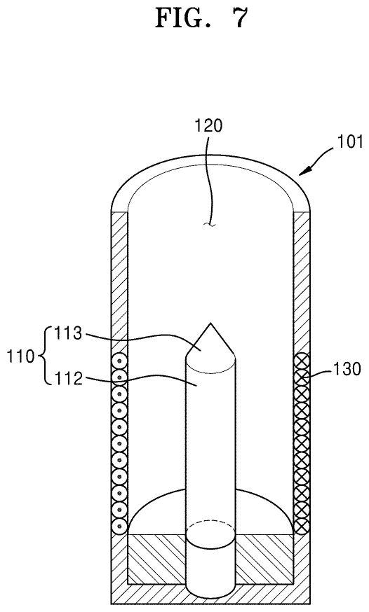

FIG. 7 is a view illustrating an example of a heater assembly according to another embodiment.

Referring to FIG. 7, the susceptor 110 may include a cylindrical base portion 112 and a pointed portion 113 formed at one end of the base portion 112. The structure of the susceptor 110 shown in FIG. 7 allows airflow holes formed at a boundary between a tobacco rod and a filter rod to gradually expand, starting from a portion close to a vertex of the pointed portion 113. Therefore, the pointed portion 113 may prevent a tobacco material from being rapidly consumed and may maintain uniform transfer of the tobacco material throughout the entire heating period.

In addition, the susceptor 110 may generate heat which is about 270° C. to about 350° C. When the susceptor 110 generates heat below 270° C., a sufficient amount of tobacco material may not be transferred due to the low temperature, and thus a taste of smoke may not be satisfactory. On the other hand, if the susceptor 110 generates heat above 350° C., the airflow holes are formed too quickly, and thus the tobacco material may not be uniformly transferred throughout the entire heating period. Also, aerosol particles may become smaller than a proper size due to a high temperature of mainstream smoke. In order to provide a more consistent taste of smoke and the more uniform amount of atomization throughout the entire heating period, the susceptor 110 may generate heat which is about 280° C. to about 320° C.

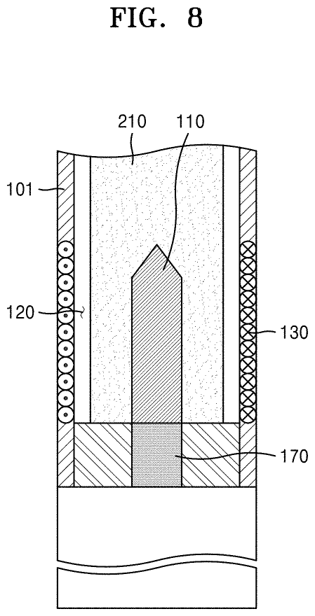

FIG. 8 is a cross-sectional view of a heater assembly according to another embodiment.

Referring to FIG. 8, a heater assembly 101 may include a heat insulating portion 170 that is coupled to the susceptor 110 and a bottom of the accommodation space 120. The heat insulating portion 170 may be formed of a material different from a material of the susceptor 110.

The heat insulating portion 170 may absorb the heat generated by the susceptor 110. The entire area of the susceptor 110 uniformly generates heat according to an induced magnetic field generated by the coil 130. However, heat of a lower portion of the susceptor 110 in contact with the bottom of the accommodation space 120 may not be discharged to the outside, and thus a temperature of the lower portion of the susceptor 110 may rapidly increase. As a temperature of a specific portion of the susceptor 110 rapidly increased, there may be a problem that a taste of smoke may be inconsistent throughout the entire heating period. In this regard, according to an embodiment, the heat insulating portion 170 including a material different from a material of the susceptor 110 is coupled to the susceptor 110 and a bottom of the accommodation space 120 to absorb heat of a lower portion of the susceptor 110. Accordingly, a rapid increase in temperature of a specific portion of the susceptor 110 may be prevented.

For example, the heat insulating portion 170 may include a tin alloy-based material having a lower thermal conductivity than the susceptor 110, a non-metal-based material such as glass or ceramic, but is not limited thereto. In addition, the heat insulating portion 170 may include a material having a higher specific heat than the susceptor 110 or may have a higher mass than the susceptor 110, such that the heat insulating portion 170 has greater heat capacity than the susceptor 110. As heat capacity of the heat insulating portion 170 increases, the heat insulating portion 170 may store more heat generated by the susceptor 110, thereby preventing a sudden increase in temperature of a specific portion of the susceptor 110.

In addition, when the heat insulating portion 170 has greater heat capacity than the susceptor 110, heat generated from a lower side of the susceptor 110 is dispersed to the heat insulating portion 170, and the heat insulating portion 170 is not heated to a high temperature due to the great heat capacity. Therefore, by reducing heat transferred to the power supplier 140 and the controller 150, the aerosol generating apparatus 100 including the heater assembly 101 according to an embodiment may prevent performance from decreasing and increase a lifetime thereof. In addition, it is possible to prevent heat from being transferred to a user who grips the aerosol generating apparatus 100.

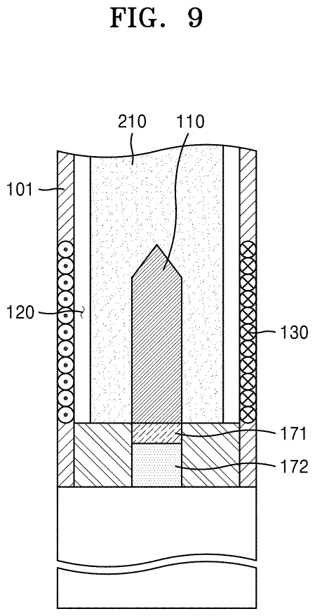

FIG. 9 is a cross-sectional view of a heater assembly according to another embodiment.

Referring to FIG. 9, the heat insulating portion 170 may be formed by stacking a plurality of members including different materials. For example, the heat insulating portion 170 may include a first member 171 having a surface in contact with the susceptor 110, and a second member 172 in contact with the opposite surface of the first member 171. If thermal conductivity of the first member 171 is lower than thermal conductivity of the second member 172, the heat insulating portion 170 may block heat transfer more efficiently.

FIG. 9 illustrates the heat insulating portion 170 including two members, but those skilled in the art to which the present embodiment pertains may understand that the heat insulating portion 170 may have a structure in which three or more members are stacked.

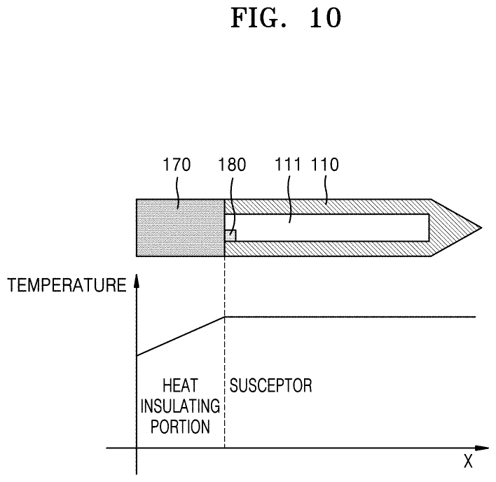

FIG. 10 illustrates a cross-sectional view of a susceptor and a heat insulating portion of a heater assembly according to another embodiment and a graph showing an example of a temperature distribution of the susceptor and the heat insulating portion.

Referring to FIG. 10, a first cavity 11 may be formed inside the susceptor 110 such that the heat insulating portion 170 is exposed in the first cavity 111. The first cavity 111 may serve to reduce a contact area between the susceptor 110 and a bottom of an accommodation space of the susceptor 110, thereby preventing a rapid temperature increase in the lower portion of the susceptor 110 more effectively.

In addition, the heater assembly 101 may further include a temperature sensor 180 arranged to be in contact with the heat insulating portion 170 in the first cavity 111. That is, the temperature sensor 180 may be arranged at a point where the susceptor 110 meets the heat insulating portion 170. The temperature sensor 180 may collect temperature information and transmit the temperature information to a controller 150. The controller 150 may receive the temperature information and may induce uniform heating of the susceptor 110 by adjusting power supplied to a coil 130.

In the graph of FIG. 10, the origin may indicate one surface of the heat insulating portion 170 that is not in contact with the susceptor 110. The x-axis may indicate a distance from one surface of the heat insulating portion 170 that is not in contact with the susceptor 110. The y-axis indicate a temperature of the susceptor 110 or the heat insulating portion 170. When the susceptor 110 is heated, heat generated by the susceptor 110 may move in a direction in which the x-axis coordinate value decreases.

When the heat insulating portion 170 includes a material with low thermal conductivity, a temperature increase of the heat insulating portion 170 may be reduced. Accordingly, the temperature of the heat insulating portion 170 may be reduced as the x-axis coordinate value decreases from a surface in contact with the susceptor 110.

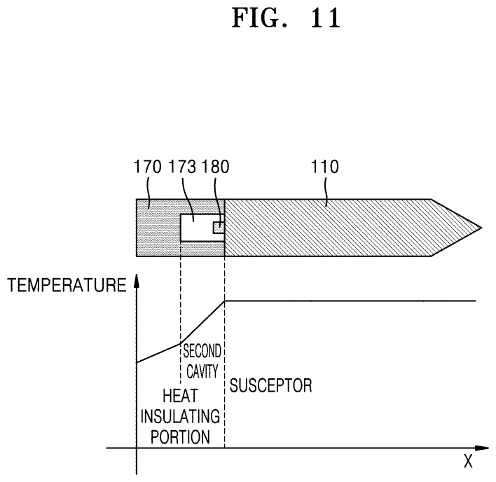

FIG. 11 illustrates a cross-sectional view of a susceptor and a heat insulating portion of a heater assembly according to another embodiment and a graph showing an example of a temperature distribution of the susceptor and the heat insulating portion.

Referring to FIG. 11, a second cavity 173 may be formed inside the heat insulating portion 170 such that the susceptor 110 is exposed in the second cavity 173. The second cavity 173 may allow heat generated by the susceptor 110 to be discharged to the second cavity 173 without being collected at the lower portion of the susceptor 110, and thus a sudden increase in temperature of the lower portion of the susceptor 110 may be prevented.

In addition, a contact area between the susceptor 110 and the heat insulating portion 170 is reduced by the second cavity 173, and thus the amount of heat transferred to the heat insulating portion 170 may be reduced. From a point on the x-axis corresponding to the contact area between the susceptor 110 and the second cavity 173, the temperature of the heat insulating portion 170 may decrease as the x-axis coordinate value decreases.

The heater assembly 101 may further include the temperature sensor 180 that is in contact with the susceptor 110 in the second cavity 173. That is, the temperature sensor 180 may be arranged at a point where the susceptor 110 meets the second cavity 173.

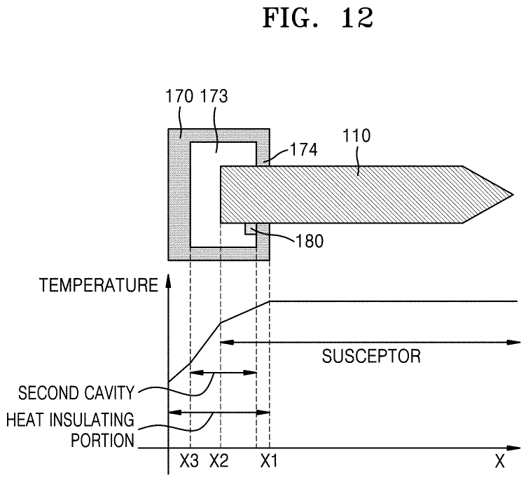

FIG. 12 illustrates a cross-sectional view of a susceptor and a heat insulating portion of a heater assembly according to another embodiment and a graph showing an example of a temperature distribution of the susceptor and the heat insulating portion.

Referring to FIG. 12, the heat insulating portion 170 may include an opening 174 in fluid communication with the second cavity 173, and at least a portion of the susceptor 110 may be inserted into the second cavity 173 through the opening 174. The second cavity 173 functions to confine the heat generated by the susceptor 110. That is, as heat of a lower portion of the susceptor 110 is released into the inside of the second cavity 173, an abnormal increase in temperature of the lower portion of the susceptor 110 may be prevented, and heat may be blocked to be transferred to other portions.

As in FIGS. 9 and 10, the x-axis represents a distance from the upstream end (i.e., the outer surface) of the heat insulating portion 170 that is not in contact with the susceptor 110. The y-axis represents a temperature of the susceptor 110 or the heat insulating portion 170. X1 indicates a point corresponding to an outer surface of the heat insulating portion 170 facing an aerosol generating article when the aerosol generating article is inserted, and X2 indicates a point corresponding to the upstream end (i.e., the bottom) of the susceptor 110 that is placed in the second cavity 173. X3 indicates corresponding to the bottom of the second cavity 173.

A section having a greater x-axis coordinate value than X1 only includes the susceptor 110, and a section from X1 to X2 includes the susceptor 110 and the heat insulating portion 170. As the x-axis coordinate value decreases from X1 where the susceptor 110 is in contact with the heat insulating portion 170, temperatures of the susceptor 110 and the heat insulating portion 170 may also decrease. A temperature of the section between X1 and X2 may be higher than a temperature from X2 and X3 due to heat emitted from the susceptor 110 inserted into the second cavity 173. From X3 to the upstream end (i.e., outer surface) of the heat insulating portion 170, the temperature may decrease as the x-axis coordinate value decreases.

The heater assembly 101 may further include the temperature sensor 180 that is in contact with the susceptor 110 in the second cavity 173. That is, the temperature sensor 180 may be arranged at a point where the susceptor 110 meets the heat insulating portion 170.

Those of ordinary skill in the art related to the present embodiments may understand that various changes in form and details can be made therein without departing from the scope of the characteristics described above. The disclosed methods should be considered in a descriptive sense only and not for purposes of limitation. The scope of the present disclosure is defined by the appended claims rather than by the foregoing description, and all differences within the scope of equivalents thereof should be construed as being included in the present disclosure.

1. A heater assembly for accommodating and heating an aerosol generating article including a tobacco rod and a filter rod, the heater assembly comprising:
an accommodation space into which the aerosol generating article is inserted;
a coil surrounding at least part of the accommodation space and configured to generate an induced magnetic field; and
a susceptor disposed in the accommodation space and configured to generate heat according to the induced magnetic field,
wherein, in a state in which the aerosol generating article is fully inserted into the accommodation space, a distal end portion of the susceptor is placed upstream of a boundary between the tobacco rod and the filter rod inside the aerosol generating article.

2. The heater assembly of claim 1, wherein the distal end portion of the susceptor is apart from the boundary by about 0.3 mm to about 0.7 mm.

3. The heater assembly of claim 1, wherein the susceptor includes a cylindrical base portion and a pointed portion formed at one end of the cylindrical base portion.

4. The heater assembly of claim 1, wherein the susceptor generates heat which is about 270° C. to about 350° C.

5. The heater assembly of claim 1, further comprising:
a heat insulating portion including a different material from the susceptor, coupled to the susceptor and a bottom of the accommodating space, and configured to absorb heat generated by the susceptor.

6. The heater assembly of claim 5, wherein the heat insulating portion is formed by stacking a plurality of members including different materials.

7. The heater assembly of claim 5, wherein a first cavity is formed inside the susceptor such that the heat insulating portion is exposed in the first cavity.

8. The heater assembly of claim 7, further comprising:
a temperature sensor arranged to be in contact with the heat insulation portion in the first cavity.

9. The heater assembly of claim 5, wherein a second cavity is formed inside the heat insulating portion such that the susceptor is exposed in the second cavity.

10. The heater assembly of claim 9, further comprising:
a temperature sensor arranged to be in contact with the susceptor in the second cavity.

11. The heater assembly of claim 9, wherein
the heat insulating portion includes an opening that is in fluid communicating with the second cavity, and
at least a portion of the susceptor is inserted into the second cavity through the opening.

12. The heater assembly of claim 11, further comprising:
a temperature sensor arranged to be in contact with the portion of the susceptor in the second cavity.

13. An aerosol generating apparatus comprising:
the heater assembly of claim 1;
a power supply configured to supply power to the heater assembly; and
a controller configured to control the power supplied to the heater assembly.
